(19) United States
(12) Patent Application Publication
(10) Pub. No.: US 2026/0201224 A1
(43) Pub. Date: Jul. 16, 2026

(54) TWO PART ADHESIVE COMPOSITION

(71) Applicant: Henkel AG & Co. KGaA, Duesseldorf (DE)

(72) Inventors: Christian D. Steinmetz, Rocky Hill, CT (US); Archith Nirmalchandar, Rocky Hill, CT (US); Zachary S. Bauman, Mountain View, CA (US); Jordan R. Kinney, Cheshire, CT (US); Jesse L. Davis, Hartford, CT (US); Tanmoy Dey, Unionville, CT (US)

(21) Appl. No.: 19/564,670

(22) Filed: Mar. 12, 2026

Related U.S. Application Data
(63) Continuation of application No. PCT/US2024/047153, filed on Sep. 18, 2024.
(60) Provisional application No. 63/538,929, filed on Sep. 18, 2023.

(51) Int. Cl. C09J 175/14; C08F 2/50; C08G 18/22; C08G 18/32; C08G 18/42; C08G 18/44; C08G 18/78; C08K 3/36

(52) U.S. Cl. CPC C09J 175/14; C08F 2/50; C08G 18/227; C08G 18/3206; C08G 18/4277; C08G 18/44; C08G 18/7843; C08K 3/36

(57) ABSTRACT

Provided herein is a two part adhesive composition comprising:
(a) a Part A composition comprising:
   (i) a hydroxyl component comprising
      a. at least two polyols, one of which includes a polyalkylene backbone and the other of which includes a polyester backbone, and each of which having a hydroxyl functionality of at least about 2, or
      b. at least one hydroxyl group and at least one (meth)acrylate group; and
   (ii) a catalyst; and
(b) a Part B composition comprising:
   (i) an isocyanato-functionalized component; and
   (ii) a compound having at least one isocyanato group and at least one (meth)acrylate group,
      wherein at least one of the Part A composition or the Part B composition comprises a photoinitiator and a filler.

### BACKGROUND

### Field

Provided herein is a two part adhesive composition comprising:
(a) a Part A composition comprising:
   (i) a hydroxyl component comprising
      a. at least two polyols, one of which includes a polyalkylene backbone and the other of which includes a polyester backbone, and each of which having a hydroxyl functionality of at least about 2, or
      b. at least one hydroxyl group and at least one (meth)acrylate group; and
   (ii) a catalyst; and
(b) a Part B composition comprising:
   (i) an isocyanato-functionalized component; and
   (ii) a compound having at least one isocyanato group and at least one (meth)acrylate group,
      wherein at least one of the Part A composition or the Part B composition comprises a photoinitiator and a filler.

### Brief Description of Related Technology

Two part polyurethane forming compositions are well known and have been available for years. Ordinarily, these compositions are based on a single cure chemistry, such as through condensation reactions between a polyol and an isocyanate to form a urethane.

While a popular solution for many bonding applications, after application these compositions take a long time to develop full strength, oftentimes up to and even longer than a week.

Accordingly, there has been a long felt, yet unmet need, for two part polyurethane forming compositions that develop strength faster and develop greater strength.

### SUMMARY

Provided herein is a two part adhesive composition comprising:
(a) a Part A composition comprising:
   (i) a hydroxyl component comprising
      a. at least two polyols, one of which includes a polyalkylene backbone and the other of which includes a polyester backbone, and each of which having a hydroxyl functionality of at least about 2, or
      b. at least one hydroxyl group and at least one (meth)acrylate group; and
   (ii) a catalyst; and
(b) a Part B composition comprising:
   (i) an isocyanato-functionalized component; and
   (ii) a compound having at least one isocyanato group and at least one (meth)acrylate group.

At least one of the Part A composition or the Part B composition comprises a photoinitiator and a filler.

When the Part A composition and the Part B composition are mixed together, disposed on substrates to be bonded and cured by any of several different techniques, a variety of superior and unexpected performance properties may be realized. Some of those performance properties are recited below in different alternatives.

In some embodiments, the two part adhesives composition demonstrates when the Part A composition and the Part B composition are mixed together, and thereafter exposed to ultraviolet radiation at a wavelength of 365 nm for a period of time of about 60 seconds and
(1) permitted to cure at room temperature for a period of time of about 1 hour, an adhesive strength of about 2 MPa or greater when disposed between two polycarbonate substrates; or
(2) permitted to cure at room temperature for a period of time of about 24 hours, an adhesive strength of about 6 MPa or greater when disposed between two polycarbonate substrates or an adhesive strength of about 10 MPa or greater when disposed a polycarbonate substrate and a FR-4 substrate; or
(3) permitted to cure at room temperature for a period of time of about 72 hours, an adhesive strength of about 8 MPa or greater when disposed between two polycarbonate substrates.

In some embodiments, the two part adhesives composition demonstrates when the Part A composition and the Part B composition are mixed together, and permitted to cure at room temperature for a period of time of about 24 hours, an adhesive strength of about 2 MPa or greater when disposed between two polycarbonate substrates.

### BRIEF DESCRIPTION OF THE FIGURES

FIG. 1 depicts a bar graph of tensile strength (measured in MPa) versus time with UV exposure of 6 samples on PC-PC substrates.

FIG. 2 depicts a bar graph of tensile strength (measured in MPa) versus time with UV exposure of 6 samples on PC-FR4 substrates.

FIG. 3 depicts a bar graph of tensile strength (measured in MPa) versus time with no UV exposure of 6 samples on PC-PC substrates and PC-FR4 substrates.

FIG. 4 depicts a bar graph of tensile strength (measured in MPa) versus time with UV exposure of 6 samples on PC-PC substrates and PC-FR4 substrates.

### DETAILED DESCRIPTION

As noted above, provided herein is a two part adhesive composition comprising:
(a) a Part A composition comprising:
   (i) a hydroxyl component comprising
      a. at least two polyols, one of which includes a polyalkylene backbone and the other of which includes a polyester backbone, and each of which having a hydroxyl functionality of at least about 2, or
      b. at least one hydroxyl group and at least one (meth)acrylate group; and
   (ii) a catalyst; and
(b) a Part B composition comprising:
   (i) an isocyanato-functionalized component; and
   (ii) a compound having at least one isocyanato group and at least one (meth)acrylate group.

At least one of the Part A composition or the Part B composition comprises a photoinitiator and a filler.

When the Part A composition and the Part B composition are mixed together, disposed on substrates to be bonded and cured by any of several different techniques, a variety of superior and unexpected performance properties may be realized. Some of those performance properties are recited below in different alternatives.

In some embodiments, the two part adhesive composition demonstrates when the Part A composition and the Part B composition are mixed together, and thereafter exposed to ultraviolet radiation at a wavelength of 365 nm for a period of time of about 60 seconds and
(1) permitted to cure at room temperature for a period of time of about 1 hour, an adhesive strength of about 2 MPa or greater when disposed between two polycarbonate substrates; and/or
(2) permitted to cure at room temperature for a period of time of about 24 hours, an adhesive strength of about 6 MPa or greater when disposed between two polycarbonate substrates or an adhesive strength of about 10 MPa or greater when disposed a polycarbonate substrate and a FR-4 substrate; and/or
(3) permitted to cure at room temperature for a period of time of about 72 hours, an adhesive strength of about 8 MPa or greater when disposed between two polycarbonate substrates.

In some embodiments, the two part adhesive composition demonstrates when the Part A composition and the Part B composition are mixed together, and permitted to cure at room temperature for a period of time of about 24 hours, an adhesive strength of about 2 MPa or greater when disposed between two polycarbonate substrates.

In many instances, each of the substrates should be substantially transmissive to radiation in the ultraviolet range of the electromagnetic spectrum. And, the substrates to be bonded may be constructed from the same material; however, they need not be. Indeed, in some instances only one of the substrates to be bonded should be substantially transmissive to radiation in the ultraviolet range of the electromagnetic spectrum.

Ordinarily the substrates to be bonded should be polycarbonate substrates and/or FR-4 substrates.

### Part A Composition

The Part A composition comprises:
(i) a hydroxyl component comprising
   a. at least two polyols, one of which includes a polyalkylene backbone and the other of which includes a polyester backbone, and each of which having a hydroxyl functionality of at least about 2, or
   b. at least one hydroxyl group and at least one (meth)acrylate group; and
(ii) a catalyst.

In one aspect, the hydroxyl component comprises at least two polyols.

One of the two polyols includes a polyalkylene backbone and the other of the two polyols includes a polyester backbone, and each has a hydroxyl functionality of at least about 2. The polyalkylene backbone may be a poly(butadiene). The polyester backbone may be a poly(carbonate). In some instances, the at least two polyols may further comprise a poly(caprolactone).

In another aspect, the hydroxyl component has at least one hydroxyl group and at least one (meth)acrylate group.

Here, the at least two polyols should each have a Mw molecular weight in the range of about 500 g/mol (in the case of ETERNACOLL PH50) to about 3,000 g/mol, such as about 900 g/mol (in the case of ETERNACOLL UM(1/3)) to about 2,000 g/mol. For instance, the Mw molecular weight may be in the range of about 500 g/mol (in the case of ETERNACOLL PH 50) to about 2,900 g/mol (in the case of Polyvest HT), or for instance about 1,300 g/mol (in the case of polyBD R20 LM).

In other aspects, one of the at least two polyols has a Mw molecular weight in the above ranges, whereas the another of the at least two polyols has a molecular weight that falls outside of the ranges.

The hydroxyl component should be present in an amount within the range of about 25 percent by weight to about 75 percent by weight, such as about 45 percent by weight to about 55 percent by weight, based on the total amount of the Part A composition.

Where the hydroxyl component comprises at least two polyols, each should have a hydroxyl functionality of at least about 2. For instance, the hydroxyl component may comprise poly(butadiene) having a hydroxyl functionality of about 2 to about 2.4 and poly(carbonate) having a hydroxyl functionality of about 2.

The hydroxyl component may further comprise a polyol having a polyamine backbone, with a hydroxyl functionality of at least about 2. Commercial examples of such hydroxyl component include those polyols sold by Huntsman Corporation under the JEFFAMINE tradename.

The hydroxyl component may comprise a copolymer having butadiene residues and carbonate residues.

The hydroxyl component may comprise a terpolymer having butadiene residues, carbonate residues and caprolactone residues.

Some suitable hydroxyl components include aliphatic alcohols containing 2 to 8 OH groups per molecule. The OH groups may be both primary and secondary. Some suitable aliphatic alcohols include, for example, ethylene glycol, propylene glycol, butane-1,4-diol, pentane-1,5-diol, hexane-1,6-diol, heptane-1,7-diol, octane-1,8-diol and higher homologs or isomers thereof which the expert can obtain by extending the hydrocarbon chain by one CH₂ group at a time or by introducing branches into the carbon chain. Also suitable are higher alcohols such as, for example, glycerol, trimethylol propane, pentaerythritol and oligomeric ethers of the substances mentioned either individually or in the form of mixtures of two or more of the ethers mentioned with one another.

Some suitable hydroxyl components include the reaction products of low molecular weight polyhydric alcohols with alkylene oxides, so-called polyether polyols. The alkylene oxides preferably contain 2 to 4 carbon atoms. Some reaction products of this type include, for example, the reaction products of ethylene glycol, propylene glycol, the isomeric butane diols, hexane diols or 4,4′-dihydroxydiphenyl propane with ethylene oxide, propylene oxide or butylene oxide or mixtures of two or more thereof. The reaction products of polyhydric alcohols, such as glycerol, trimethylol ethane or trimethylol propane, pentaerythritol or sugar alcohols or mixtures of two or more thereof, with the alkylene oxides mentioned to form polyether polyols are also suitable. Thus, depending on the desired molecular weight, products of the addition of only a few mol ethylene oxide and/or propylene oxide per mol or of more than one hundred mol ethylene oxide and/or propylene oxide onto low molecular weight polyhydric alcohols may be used. Other polyether polyols may be obtained by condensation of, for example, glycerol or pentaerythritol with elimination of water. Some suitable polyols include those polyols obtainable by polymerization of tetrahydrofuran.

The polyethers are reacted in known manner by reacting the starting compound containing a reactive hydrogen atom with alkylene oxides, for example ethylene oxide, propylene oxide, butylene oxide, styrene oxide, tetrahydrofuran or epichlorohydrin or mixtures of two or more thereof.

Suitable starting compounds are, for example, water, ethylene glycol, 1,2- or 1,3-propylene glycol, 1,4- or 1,3-butylene glycol, hexane-1,6-diol, octane-1,8-diol, neopentyl glycol, 1,4-hydroxymethyl cyclohexane, 2-methyl propane-1,3-diol, glycerol, trimethylol propane, hexane-1,2,6-triol, butane-1,2,4-triol, trimethylol ethane, pentaerythritol, mannitol, sorbitol, methyl glycosides, sugars, phenol, isononylphenol, resorcinol, hydroquinone, 1,2,2- or 1,1,2-tris-(hydroxyphenyl)-ethane, ammonia, methyl amine, ethylenediamine, tetra- or hexamethylenediamine, triethanolamine, aniline, phenylenediamine, 2,4- and 2,6-diaminotoluene and polyphenyl polymethylene polyamines, which may be obtained by aniline/formaldehyde condensation, or mixtures of two or more thereof.

Some suitable polyols include diol EO/PO (ethylene oxide/propylene oxide) block copolymers, EO-tipped polypropylene glycols, or alkoxylated bisphenol A.

Some suitable polyols include polyether polyols modified by vinyl polymers. These polyols can be obtained, for example, by polymerizing styrene or acrylonitrile or mixtures thereof in the presence of polyetherpolyol.

Some suitable polyols include polyester polyols, such as those obtained by reacting low molecular weight alcohols, more particularly ethylene glycol, diethylene glycol, neopentyl glycol, hexanediol, butanediol, propylene glycol, glycerol or trimethylol propane, with caprolactone. Other suitable polyhydric alcohols for the production of polyester polyols are 1,4-hydroxymethyl cyclohexane, 2-methyl propane-1,3-diol, butane-1,2,4-triol, triethylene glycol, tetraethylene glycol, polyethylene glycol, dipropylene glycol, polypropylene glycol, dibutylene glycol and polybutylene glycol.

Some suitable polyols include polyester polyols obtained by polycondensation. Thus, dihydric and/or trihydric alcohols may be condensed with less than the equivalent quantity of dicarboxylic acids and/or tricarboxylic acids or reactive derivatives thereof to form polyester polyols. Suitable dicarboxylic acids are, for example, adipic acid or succinic acid and higher homologs thereof containing up to 16 carbon atoms, unsaturated dicarboxylic acids, such as maleic acid or fumaric acid, cyclohexane dicarboxylic acid (“CHDA”), and aromatic dicarboxylic acids, more particularly the isomeric phthalic acids, such as phthalic acid, isophthalic acid or terephthalic acid. Citric acid and trimellitic acid, for example, are also suitable tricarboxylic acids. The acids mentioned may be used individually or as mixtures of two or more thereof. Polyester polyols of at least one of the dicarboxylic acids mentioned and glycerol which have a residual content of OH groups are suitable. Suitable alcohols include but not limited to propylene glycol, butane diol, pentane diol, hexanediol, ethylene glycol, diethylene glycol, triethylene glycol, dipropylene glycol, tripropylene glycol, cyclohexanedimethanol (“CHDM”), 2-methyl-1,3-propanediol (“MPDiol”), or neopentyl glycol or isomers or derivatives or mixtures of two or more thereof. High molecular weight polyester polyols may be used in the second synthesis stage and include, for example, the reaction products of polyhydric, preferably dihydric, alcohols (optionally together with small quantities of trihydric alcohols) and polybasic, preferably dibasic, carboxylic acids. Instead of free polycarboxylic acids, the corresponding polycarboxylic anhydrides or corresponding polycarboxylic acid esters with alcohols preferably containing 1 to 3 carbon atoms may also be used (where possible). The polycarboxylic acids may be aliphatic, cycloaliphatic, aromatic or heterocyclic or both. They may optionally be substituted, for example by alkyl groups, alkenyl groups, ether groups or halogens. Suitable polycarboxylic acids are, for example, succinic acid, adipic acid, suberic acid, azelaic acid, sebacic acid, phthalic acid, isophthalic acid, terephthalic acid, trimellitic acid, phthalic anhydride, tetrahydrophthalic anhydride, hexahydrophthalic anhydride, tetrachlorophthalic anhydride, endomethylene tetrahydrophthalic anhydride, glutaric anhydride, maleic acid, maleic anhydride, fumaric acid, dimer fatty acid or trimer fatty acid or mixtures of two or more thereof. Small quantities of monofunctional fatty acids may optionally be present in the reaction mixture.

Polyester polyols may optionally contain a small number of terminal carboxyl groups. Polyesters obtainable from lactones, for example based on ϵ-caprolactone (also known as “polycaprolactones”), or hydroxycarboxylic acids, for example w-hydroxycaproic acid, may also be used.

Polyester polyols of oleochemical origin may also be used. Oleochemical polyester polyols may be obtained, for example, by complete ring opening of epoxidized triglycerides of a fatty mixture containing at least partly olefinically unsaturated fatty acids with one or more alcohols containing 1 to 12 carbon atoms and subsequent partial transesterification of the triglyceride derivatives to form alkyl ester polyols with 1 to 12 carbon atoms in the alkyl group.

Some suitable polyols include C36 dimer diols and derivatives thereof. Some suitable polyols include castor oil and derivatives thereof. Some suitable polyols include fatty polyols, for example the products of hydroxylation of unsaturated or polyunsaturated natural oils, the products of hydrogenations of unsaturated and polyunsaturated polyhydroxy natural oils, polyhydroxyl esters of alkyl hydroxyl fatty acids, polymerized natural oils, soybean polyols, and alkylhydroxylated amides of fatty acids. Some suitable polyols include the hydroxy functional polybutadienes known, for example, by the commercial name of “polyBD” available from Cray Valley USA LLC, Exton, PA. Some suitable polyols include polyisobutylene polyols. Some suitable polyols include polyacetal polyols. Polyacetal polyols are understood to be compounds obtainable by reacting glycols, for example diethylene glycol or hexanediol or mixtures thereof, with formaldehyde. Polyacetal polyols may also be obtained by polymerizing cyclic acetals. Some suitable polyols include polycarbonate polyols. Polycarbonate polyols may be obtained, for example, by reacting diols, such as propylene glycol, butane-1,4-diol or hexane-1,6-diol, diethylene glycol, triethylene glycol or tetraethylene glycol or mixtures of two or more thereof, with diaryl carbonates, for example diphenyl carbonate, or phosgene. Some suitable polyols include polyamide polyols.

Some suitable polyols include polyacrylates containing OH groups. These polyacrylates may be obtained, for example, by polymerizing ethylenically unsaturated monomers bearing an OH group. Such monomers are obtainable, for example, by esterification of ethylenically unsaturated carboxylic acids and dihydric alcohols, the alcohol generally being present in a slight excess. Ethylenically unsaturated carboxylic acids suitable for this purpose are, for example, acrylic acid, methacrylic acid, crotonic acid or maleic acid. Corresponding OH-functional esters are, for example, 2-hydroxyethyl acrylate, 2-hydroxyethyl methacrylate, 2-hydroxypropyl acrylate, 2-hydroxypropyl methacrylate, 3-hydroxypropyl acrylate or 3-hydroxypropyl methacrylate or mixtures of two or more thereof.

Particularly desirable commercially available polyols suitable for use herein include POLYVEST BD R20LM, available commercially from Cray Valley, is reported to be a polybutadiene, having a functionality of 2, a molecular weight of 1300, a Tg of −70, and a viscosity of 1500 (30° C.); POLYVEST HT, available commercially from Evonik, is reported to be a polybutadiene, having a KOH hydroxyl value of 44-51, a functionality of 2.4, a molecular weight of 2900, a density of 0.90-0.92, a Tg of −80, and a viscosity of 4000-5000 (30° C.); ETERNACOLL UM(1/3), available commercially from UBE, is reported to be a cyclic aliphatic copolycarbonate, having a KOH hydroxyl value of 115-135, a functionality of 2, a molecular weight of 900, and a viscosity of <8000 (80° C.); ETERNACOLL PH50, available commercially from UBE, is reported to be an alipathic polycarbonate, having a KOH hydroxyl value of 204-244, a functionality of 2, a molecular weight of 500, and a viscosity of 65-120 (75° C.); MULTRANOL 4012, available commercially from Covestro, is reported to be a polypropylene oxide ether, having a functionality of 3, and a molecular weight of 450; MULTRANOL 8175, available commercially from Covestro, is reported to be a polypropylene oxide ether, having a KOH hydroxyl value of 350-390, a functionality of 3, a molecular weight of 450, and a viscosity of 232-412 (25° C.); DESMOPHEN 1380 BT, available commercially from Covestro, is reported to be a polypropylene oxide ether, having a KOH hydroxyl value of 370-400, a functionality of 3, a molecular weight of 438, a density of 1.03, and a viscosity of 550-650 (25° C.); PolyQ 40-480, available commercially from Monument Chemical, is reported to be a polyether polyol based on ethylene diamine, having a KOH hydroxyl value of 460-500, a functionality of 4, a molecular weight of 468, and a density of 1.025; EH diol, available commercially from Dixie Chemicals, is reported to be 2-ethylhexan-1,3-diol, a functionality of 2, a molecular weight of 146, and a density of 0.942; VORANOL 230-056, available commercially from Dow, is reported to be a polyether, having a KOH hydroxyl value of 54.5-57.5, a functionality of 3, a molecular weight of 3003, a density of 1.01, and a viscosity of 484 cSt (77° C.); VORANOL 230-112, available commercially from Dow, is reported to be a polyether, having a KOH hydroxyl value of 106-119, a functionality of 3, a molecular weight of 1500, a density of 1.014, and a viscosity of 135 (100° F.); and VORANOL 230-660, available commercially from Dow, is reported to be a polyether, having a KOH hydroxyl value of 660.5, a functionality of 3, a molecular weight of 250, a density of 1.09, and a viscosity of 298 (38° C.).

Still other polyols suitable for use herein include poly ip, available commercially from Idemitsu, is reported to be a poly isoprene polyol; poly bd R-15HT, available commercially from Idemitsu, is reported to be a polybutadiene polyol; Nisso-PB G-1000, available commercially from Nippon Soda, is reported to be a polybutadiene polyol (high 1,2 vinyl addition >85%), having a KOH hydroxyl value of 68-78, a functionality of 2, an equivalent weight of 1400 g/mol, a density of 0.88, and a viscosity of 7500 (45° C.); Nisso-PB G-2000, available commercially from Nippon Soda, is reported to be a polybutadiene polyol (high 1,2 vinyl addition >85%), having a KOH hydroxyl value of 35-55, a functionality of 2, an equivalent weight of 1900 g/mol, a density of 0.88, and a viscosity of 13500 (45° C.); Nisso-PB G-3000, available commercially from Nippon Soda, is reported to be a polybutadiene polyol (high 1,2 vinyl addition >90%), having a KOH hydroxyl value of 27+, a functionality of 2, an equivalent weight of 3000 g/mol, a density of 0.88, and a viscosity of 31000 (45° C.); BENEBiOL product line, available commercially from Mitsubishi Chemicals, is reported to be a polycarbonate diol based product line with high bio-content; and the Placcel product line, available commercially from Daicel ChemTech, Inc., is reported to be polycaprolactone diols, triols, tetraols, and polycarbonate diols.

As commercially available examples of a hydroxyl component having at least one hydroxyl group and at least one (meth)acrylate group, Placcel FA1DDM is available commercially from Daicel ChemTech, Inc., and is reported to be caprolactone-modified acrylate, with hydroxyl and methacrylic functionality; EBECRYL 117 is available commercially from Allnex, and is reported to be HEMA; and SR495 B is available commercially from Sartomer, and is reported to be a caprolactone acrylate, with hydroxyl and acrylic functionality.

The hydroxyl component may be present in an amount within the range of about 10 percent by weight to about 95 percent by weight, such as about 25 percent by weight to about 75 percent by weight, based on the total amount of the Part A composition.

The catalyst may be a condensation catalyst, in which case it may be selected from zinc-containing catalysts, tin-containing catalysts, and bismuth-containing catalysts, and combinations thereof. Examples of such condensation catalysts include BiCAT Z from Shepherd Chemical Company, KKAT XK-651 from King Industries, and Fomrez UL-38 from Galata Chemicals.

The catalyst may be present in an amount in the range of about 0.1 percent by weight to about 1 percent by weight, such as about 0.7 percent by weight to about 0.8 percent by weight, desirably about 0.75 percent by weight, based on the total amount of the Part A composition.

### Part B Composition

The Part B composition comprises:
(i) an isocyanato-functionalized component; and
(ii) a compound having at least one isocyanato group and at least one (meth)acrylate group.

The isocyanato-functionalized component is embraced by the following structure:

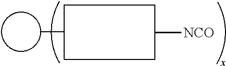

where:
x is an integer from 1 to about 10, such as about 2 to about 5;

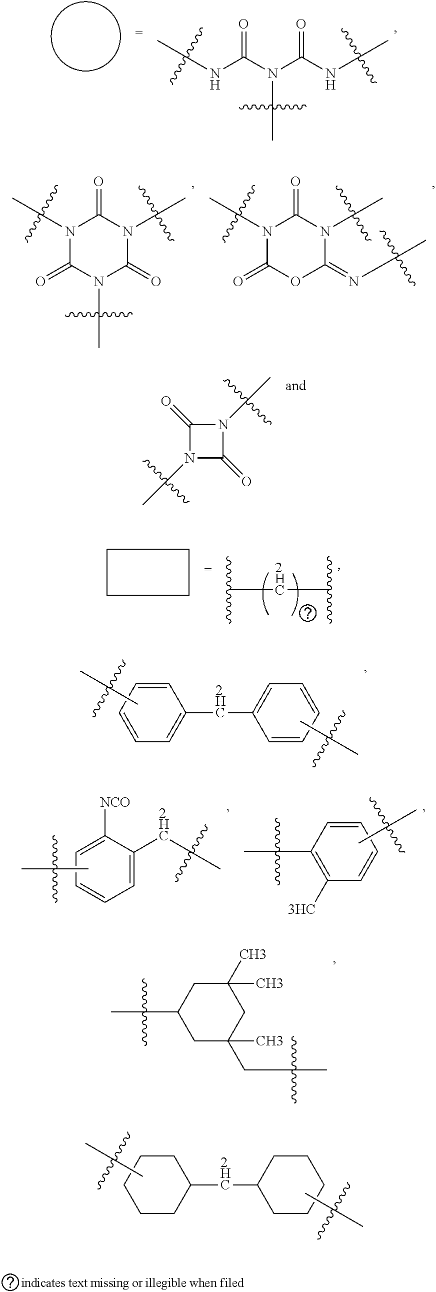

An example of such an isocyanato-functionalized component is an aliphatic polyisocyanate biuret, for instance

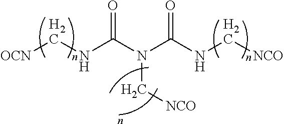

where n is an integer from 1 to about 10, such as about 2 to about 5.

A specific aliphatic polyisocyanate—polyisocyanate HDI-biuret—is represented by the structure below:

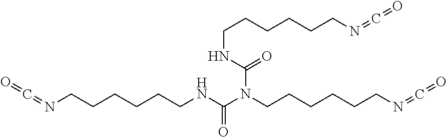 [SMILES: O=C=NCCCCCCNC(=O)N(CCCCCCN=C=O)C(=O)NCCCCCCN=C=O]

Other general structures of the isocyanato-functionalized component include

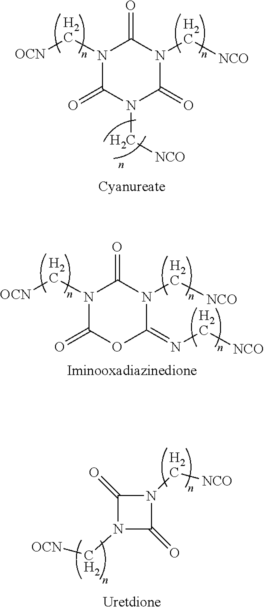

where in each of these three instances n is as defined above.

Examples of the isocyanato-functionalized component include monomeric, oligomeric or polymeric, or pre-polymers of isocyanates, such as monomeric or polymeric diphenylmethanediisocyanate (“MDI”), isocyanate functional pre-polymers, or mixtures thereof. Such components are understood to have on average two or more isocyanate groups.

In some embodiments the polyisocyanate component comprises about 50 percent by weight or less monomeric polyisocyanates by weight of the polyisocyanate component. Monomeric MDI and its isomers are preferred and may be used exclusively if monomeric polyisocyanates are present in the polyisocyanate component. In some embodiments the polyisocyanate component preferably comprises polymeric MDI, a MDI pre-polymer, monomeric MDI or mixtures thereof.

Some suitable polyisocyanates include hydrogenated MDI (“HMDI”), xylylene diisocyanate (“XDI”), tetramethyl xylylene diisocyanate (“TMXDI”), 4,4′-diphenyl dimethyl-methane diisocyanate, di- and tetraalkylene diphenylmethane diisocyanate, 4,4′-dibenzyl diisocyanate, 1,3-phenylene diisocyanate, 1,4-phenylene diisocyanate, 1-methyl-2,4-diisocyanatocyclohexane, 1,6-diisocyanato-2,2,4-trimethyl hexane, 1,6-diisocyanato-2,4,4-trimethyl hexane, 1-isocyanatomethyl-3-isocyanato-1,5,5-trimethyl cyclohexane (“IPDI”), chlorinated and brominated diisocyanates, phosphorus-containing diisocyanates, 4,4′-diisocyanatophenyl perfluoroethane, tetramethoxybutane-1,4-diisocyanate, butane-1,4-diisocyanate, hexane-1,6-diisocyanate (“HDI”), dicyclohexylmethane diisocyanate, cyclohexane-1,4-diisocyanate, ethylene diisocyanate, phthalic acid-bis-isocyanatoethyl ester; diisocyanates containing reactive halogen atoms, such as 1-chloromethylphenyl-2,4-diisocyanate, 1-bromomethylphenyl-2,6-diisocyanate or 3,3-bis-chloromethylether 4,4′-diphenyl diisocyanate, trimethyl hexamethylene diisocyanate, 1,4-diisocyanatobutane, 1,12-diisocyanatododecane, dimer fatty acid diisocyanate, tetramethylene diisocyanate, hexamethylene diisocyanate, undecane diisocyanate, dodecamethylene diisocyanate, 2,2,4-trimethylhexane-2,3,3-trimethylhexamethylene diisocyanate, 1,3-cyclohexane diisocyanate, 1,4-cyclohexane diisocyanate, 1,3- and 1,4-tetramethyl xylene diisocyanate, isophorone, 4,4-dicyclohexylmethane, tetramethylxylylene (“TMXDI”) and lysine ester diisocyanate.

Some suitable polyisocyanates include aromatic polyisocyanates. Aromatic polyisocyanates are characterized by the fact that the isocyanate groups are positioned directly on the benzene ring. Suitable aromatic diisocyanates include 4,4′-diphenyl methane diisocyanate (“MDI”) and its isomers, toluene diisocyanate (“TDI”) and its isomers and naphthalene-1,5-diisocyanate (“NDI”).

Some suitable polyisocyanates include sulfur-containing polyisocyanates that are obtained, for example, by reaction of 2 mol hexamethylene diisocyanate with 1 mol thiodiglycol or dihydroxydihexyl sulfide.

Aliphatic polyisocyanates with two or more isocyanate functionality formed by biuret linkage, uretdione linkage, allophanate linkage, and/or by trimerization are suitable.

Particularly desirable commercially available examples of the isocyanato-functionalized component suitable for use herein include DESMODUR N 3400, available commercially from Covestro, is reported to be an aliphatic polyisocyanate (HDI uretdione), having an NCO content of 21.1-22.5, an equivalent weight of 193, a density of 1.14 (25° C.), and a viscosity of 175 (23° C.); DESMODUR N 100, available commercially from Covestro, is reported to be an aliphatic polyisocyanate HDI biuret, having an NCO content of 22, a functionality of 3.8, an equivalent weight of 190, a density of 1.14 (20° C.), and a viscosity of 10000(23° C.); DESMODUR N 3200, available commercially from Covestro, is reported to be an aliphatic polyisocyanate HDI-Biuret, having an NCO content of 22.5-23.5, a functionality of 3.5, an equivalent weight of 183 g/mol, a density of 1.13 (20° C.), and a viscosity of 2100 (25° C.); DESMODUR ULTRA N 3300, available commercially from Covestro, is reported to be an aliphatic polyisocyanate HDI Trimer, having an NCO content of 21.5-22.1, 3.5, an equivalent weight of 195 g/mol, a density of 1.07 (20° C.), and a viscosity of 2250-3750 (23° C.); DESMODUR ULTRA N 3600, available commercially from Covestro, is reported to be a HDI Trimer, having an NCO content of 23, a functionality of 3.2, an equivalent weight of 185 g/mol, and a viscosity of 1200 (23° C.); DESMODUR ULTRA N 3700, available commercially from Covestro, is reported to be a HDI Trimer, having an NCO content of 20, a functionality of 3.9, an equivalent weight of 210 g/mol, and a viscosity of 16000 (23° C.); DESMODUR ULTRA N 3800, available commercially from Covestro, is reported to be a HDI Trimer, having an NCO content of 11, a functionality of 3.8, an equivalent weight of 380 g/mol, and a viscosity of 6000 (23° C.); DESMODUR ULTRA N 3900, available commercially from Covestro, is reported to be a HDI Trimer, having an NCO content of 12, a functionality of 3.5, an equivalent weight of 350 g/mol, and a viscosity of 730 (23° C.); DESMODUR N 3500, available commercially from Covestro, is reported to be a HDI allophanate/isocyanureate, having an NCO content of 19.5, a functionality of >5, an equivalent weight of 215 g/mol, and a viscosity of 35000 (23° C.); DESMODUR N 31000, available commercially from Covestro, is reported to be a HDI uretdione/isocyanureate, having an NCO content of 23, a functionality of 3, an equivalent weight of 185 g/mol, and a viscosity of 500 (23° C.); DESMODUR N 31100, available commercially from Covestro, is reported to be a HDI allophanate, having an NCO content of 20, a functionality of 2.5, an equivalent weight of 215 g/mol, and a viscosity of 500 (23° C.); DESMODUR ultra NZ 200, available commercially from Covestro, is reported to be a HDI/IPDI isocyanureate, having an NCO content of 21, a functionality of 3.2, an equivalent weight of 200 g/mol, and a viscosity of 22500 (23° C.); DESMODUR NZ 300, available commercially from Covestro, is reported to be a HDI/IPDI isocyanureate, having an NCO content of 21, a functionality of 3, an equivalent weight of 200 g/mol, and a viscosity of 3000 (23° C.); and DESMODUR ECO N 7300, available commercially from Covestro, is reported to be based on PDI, having an NCO content of 21.5, a functionality of 3.7, an equivalent weight of 195 g/mol, and a viscosity of 9500 (23° C.).

The isocyanato-functionalized component may be present in an amount in the range of up to about 75 percent by weight, such as about 25 percent by weight to about 50 percent by weight, based on the total amount of the Part B composition.

The compound having at least one isocyanato group and at least one (meth)acrylate group is embraced by the following structure:

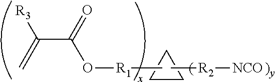

wherein:
x is from 1 to about 5, for instance x may be 1 (EBECRYL 4150), 1-1.4 (LAROMER PR 9000), or 3.4 (EBECRYL 4250);
y is from 1 to about 4, for instance y may be 1.4 (EBECRYL 4250), 2 (LAROMER PR 9000), or 2 (EBECRYL 4150);
R₁ and R₂ may or may not be present, but when present represent alkylene linkages of from one to about 10 carbon atoms, alkenylene linkages of from 2 to about 10 carbon atoms, alkynylene linkages of from 2 to about 10 carbon atoms, or arylene linkages of from 5 to about 12 carbon atoms; R₃ is hydrogen or an alkyl group of from one to about 10 carbon atoms; and

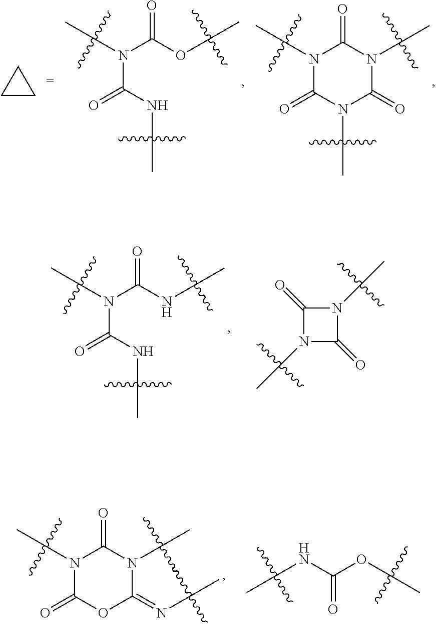

Examples of the compound having at least one isocyanato group and at least one (meth)acrylate group include 2-isocyanatoethyl methacrylate (Sigma Aldrich) 2-isocyantoethyl acrylate (TCI Chemicals), 2-(2-methacryloyloxyethyloxy)ethyl isocyanate, and 1,1-(bisacryloyloxymethyl)ethyl isocyanate (Karenz). Particularly desirable, commercially available examples suitable for use herein include EBECRYL 4150, available commercially from Allnex, and is reported to be an isocyanate functional urethane acrylate, having an NCO content of 11.8-13.8, a density of 1.18 (20° C.), and a viscosity of 7500-12500 (23° C.). LAROMER PR 9000 is an HDI trimer Allophanate; EBECRYL 4150 is an HDI trimer cyanureate.

The compound having at least one isocyanato group and at least one (meth)acrylate group is present in an amount in the range of about 15 percent by weight up to below about 100 percent by weight, such as about 40 percent by weight to about 60 percent by weight, based on the total amount of the Part B composition.

The photoinitiator is selected from acylphosphine oxides, phenyl ketones, phenyl aceto ketones, alpha hydroxy ketones, diaryl ketones, Micheler's ketones, thioxanthones, quinones and 3-keto coumarins. Commercially available examples of the acyl phosphine oxides for instance include

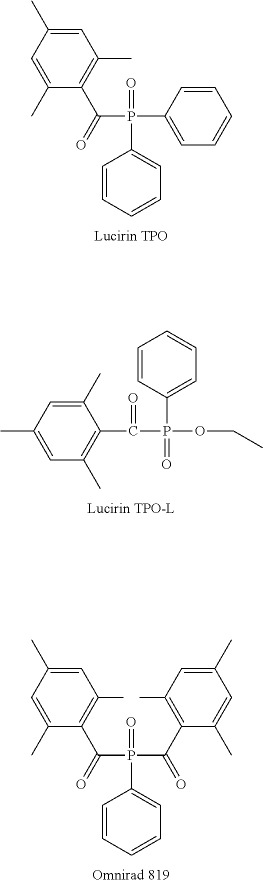 [SMILES: Cc1cc(C)c(C(=O)P(=O)(c2ccccc2)c2ccccc2)c(C)c1 ; CCOP(=O)(C(=O)c1c(C)cc(C)cc1C)c1ccccc1 ; Cc1cc(C)c(C(=O)P(=O)(C(=O)c2c(C)cc(C)cc2C)c2ccccc2)c(C)c1]

The photoinitiator is present in an amount in the range of about 0.5 percent by weight to about 2 percent by weight, based on the total weight of the Part B composition.

In practice the Part A composition and the Part B composition are each formulated and then held separately until ready for use. Ordinarily, the Part A composition and the Part B composition are maintained in separate barrels of a dual barrel cartridge, equipped with a mixing tip.

The Part A composition and the Part B composition may be used in a 1:1 by volume relationship, a 2:1 by volume relationship, a 1:2 by volume relationship, a 1:4 by volume relationship or a 2:3 by volume relationship.

### Filler

At least one of the Part A composition or the Part B composition includes a filler.

The filler is selected from silicas, such as fumed silica and other treated silicas.

The filler may be present in an amount in the range of about 0.1 percent by weight to about 10 percent by weight, such as about 1 percent by weight to about 5 percent by weight, based on the total amount of the Part B composition. A commercially available example of such silicas is CAB-O-SIL TS-720 Fumed Silica, from Cabot Corporation, which is described by the manufacturer as siloxanes and silicones, di-Me, reaction products with silica.

### Examples

Table 1 provides the constituents and their relative amounts used in various Part A compositions.

TABLE 1

| | Sample Nos.//Amt (ratio A:B//wt %) | | | | | |
|---|---|---|---|---|---|---|
| | 1 | 2 | 3 | 4 | 5 | 6 |
| Constituents | 1:1 | 1:2 | 1:2 | 1:1 | 1:1 | 1:1 |
| POLY BD 20 LM | 53.2 | — | — | 47 | — | 46.5 |
| POLYVEST HT | — | — | — | — | 30 | — |
| ETERNACOLL UM90 | — | — | 10 | 8.2 | 15.7 | 9.7 |
| (1/3) | | | | | | |
| ETERNACOLL PH50 | — | 10 | — | — | — | — |
| MULTRANOL 4012 | 19.7 | — | — | 17 | 26 | — |
| MULTRANOL 8175 | — | — | — | — | — | — |
| DESMOPHEN 1380 | — | — | — | — | — | 17 |
| BT | | | | | | |
| POLYQ 40-480 | 20 | 10 | 10 | 20 | 20 | 20 |
| EH-DIOL | — | 15 | 15 | — | — | — |
| VORANOL 230-056 | — | 10 | 10 | — | — | — |
| VORANOL 230-660 | — | 45 | 45 | — | — | — |
| VORANOL 230-112 | — | 5 | 5 | — | — | — |
| UOP L Powder | 3 | 3 | 3 | 3 | 3 | 2 |
| Cab-O-Sil TS 720 | 4 | 1.5 | 1.5 | 4 | 3.5 | 4 |
| KKat XK 640 | 0.8 | 0.8 | 0.8 | 0.8 | 0.8 | 0.8 |

Table 2 below provides the constituents and their relative amounts in various Part B compositions.

TABLE 2

| | Sample Nos.//Amt (ratio A:B//wt %) | | | | | |
|---|---|---|---|---|---|---|
| | 1 | 2 | 3 | 4 | 5 | 6 |
| Constituents | 1:1 | 1:2 | 1:2 | 1:1 | 1:1 | 1:1 |
| DESMODUR N 3200 | 48.5 | 48.5 | 48.5 | 48.5 | 47.5 | 47 |
| EBECRYL 4150 | 48.5 | 48.5 | 48.5 | 48.5 | 47.5 | 47 |
| OMNIRAD TPO-L | 2 | 2 | 2 | 2 | 2 | 2 |
| IRGACURE 819 | 1 | 1 | 1 | 1 | — | — |
| CAB-O-SIL TS 720 | — | — | — | — | 3 | 4 |

In Tables 3A-3C, the various Part A/Part B compositions from Tables 1 and 2 were applied to the noted substrates and exposed to various conditions. More specifically, lap shears constructed from the noted materials were assembled with a 0.5 inch overlap, and 5 mil glass spacer beads to induce a gap between the mated substrates. Disposed between the overlap is each of the samples. The assembly was oriented so that the radiation transmissive substrate was facing upward. Radiation was generated using a LOCTITE-branded 365 nm Flood Array at 500 mW/cm² intensity, and the time for cure was between about 10 seconds to about 120 seconds for a time of about 45 seconds to about 60 seconds.

TABLE 3A

| | Sample Nos.//Lap shear strength (MPa) | | | | | |
|---|---|---|---|---|---|---|
| Substrates and Exposure | 1 | 2 | 3 | 4 | 5 | 6 |
| PC-PC (UV 60 s + RT 5 min) | 0.94 | 0.31 | 0.28 | 1.17 | 1.63 | 1.13 |
| PC-PC (UV 60 s + RT 1 h) | 2.09 | 0.80 | 0.73 | 2.33 | 2.80 | 4.08 |
| PC-PC (UV 60 s + RT 24 h) | 1.43 | 0.61 | 0.42 | 5.95 | 10.32 | 8.24 |
| PC-PC (UV 60 s + RT 72 h) | 1.43 | 3.0 | 0.89 | 8.12 | 8.42 | 8.26 |

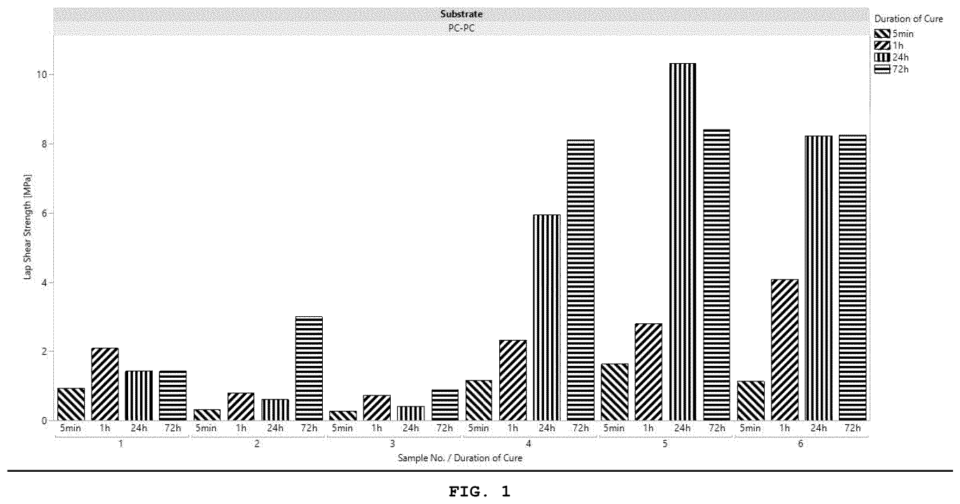

See also FIG. 1 for a visual depiction of these results.

TABLE 3B

| | Sample Nos.//Lap shear strength (MPa) | | | | | |
|---|---|---|---|---|---|---|
| Substrates and Exposure | 1 | 2 | 3 | 4 | 5 | 6 |
| PC-FR4 (UV 60 s + RT 5 | 1.82 | 0.39 | 0.26 | 2.72 | 2.06 | 1.74 |
| min) | | | | | | |
| PC-FR4 (UV 60 s + RT 1 h) | 2.68 | 0.90 | 1.03 | 3.69 | 7.24 | 5.35 |
| PC-FR4 (UV 60 s + RT 24 h) | 3.10 | 2.96 | 3.18 | 10.14 | 12.53 | 11.27 |
| PC-FR4 (UV 60 s + RT 72 h) | 3.33 | 2.46 | 5.59 | 8.29 | 12.13 | 9.73 |

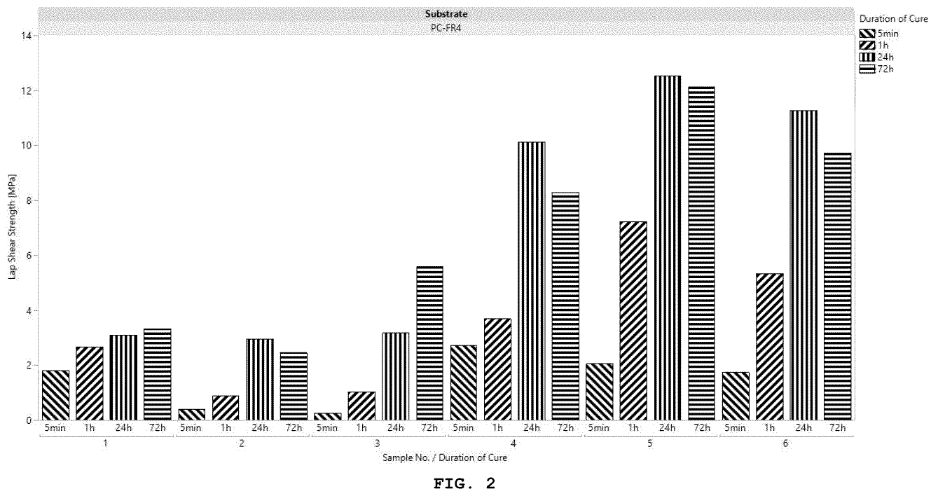

See also FIG. 2 for a visual depiction of these results.

TABLE 3C

| | Sample Nos.//Lap shear strength (MPa) | | | | | |
|---|---|---|---|---|---|---|
| Substrates and Exposure | 1 | 2 | 3 | 4 | 5 | 6 |
| PC-PC (RT 24 h) | 3.47 | 1.34 | 0.74 | 2.21 | 1.81 | 2.06 |
| FR4-FR4 (RT 24 h) | 4.5 | 1.90 | 4.53 | 6.54 | 8.03 | 7.54 |

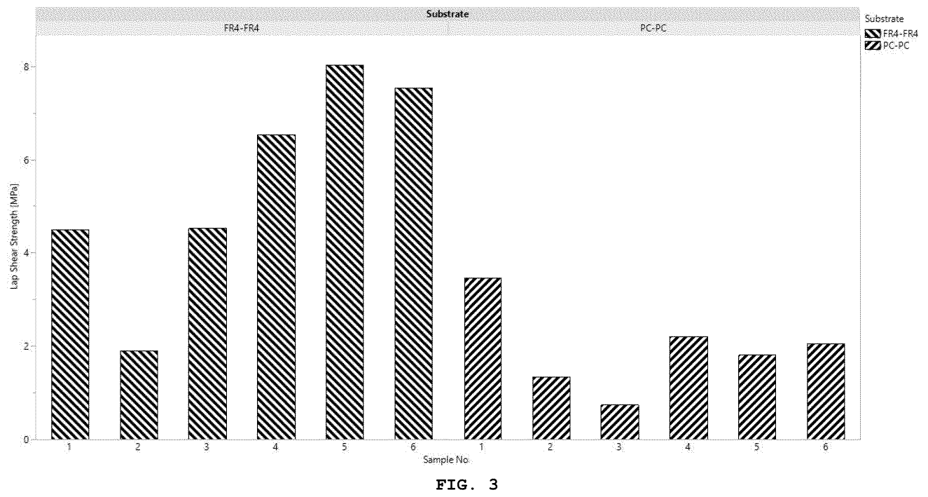

See also FIG. 3 for a visual depiction of these results.

The evaluation was conducted in accordance with ASTM D1002, and the observed results were recorded in Tables 3A-3C above and shown in the accompanying FIGS. 1-3, as noted.

Each of Sample Nos. 3-6 demonstrated the benefit of achieving a level of adhesion when two substrates are mated, whether or not exposed to ultraviolet light. When exposed to ultraviolet light however it is seen that the level of adhesion improves dramatically.

In Table 3D, two UV acrylic/moisture cure compositions are shown for comparative performance; the first of which is referred to as “CE 1” and the second of which is available commercially under the trade name LOCTITE ECCOBOND 9060F.

CE 1 is described to have on a percent by weight basis: Isocyanatoacrylate, 30-60; High boiling methacrylate, 10-30; Isocyanatoacrylate, 10-30; Silica, amorphous, treated, 1-5; Photoinitiator, 1-5; Zeolites, 1-5; 2-Hydroxy-2-methylpropiophenone, 1-5; diphenyl(2,4,6-trimethylbenzoyl)phosphine oxide, 0.1-1; 4-isocyanatosulphonyltoluene, 0.1-1; acrylic acid, 3-(trimethoxysilyl)propyl ester, 0.1-1; Quartz (SiO2), <1% respirable, 0.1-1; and Hexamethylene-1,6-diisocyanate, 0.1-1. And LOCTITE ECCOBOND 9060F is described to contain on a percent by weight basis a Mix of 2-hydroxyethyl acrylate and aliphatic isocyanate, 30-60; Hexane, 1,6-diisocyanato-, homopolymer, 10-30; Isobornyl acrylate, 10-30; N,N-Dimethylacrylamide, 10-30; Siloxanes and Silicones, di-Me, reaction products with silica, 1-5; Photoinitiator, 1-5; Zeolites, 1-5; diphenyl(2,4,6-trimethylbenzoyl)phosphine oxide, 1-5; 4-isocyanatosulphonyltoluene, 0.1-1; Trimethoxyphenylsilane, 0.1-1; Triphenyl phosphite, 0.1-1; and Quartz (SiO2), <1% respirable, 0.1-1.

Here, the noted lap shears were assembled with 0.5 inch overlap, and 5 mil glass spacer beads to induce a gap and arrested with spring clamps. Each of the samples were disposed within that overlap and allowed to cure at room temperature for a period of time of about 24 hours prior to evaluation. The evaluation was conducted in accordance with ASTM D1002. When CE 1 and LOCTITE ECCOBOND 9060F were evaluated in this manner, little to no adhesive performance was observed. On the other hand, when these materials were exposed to radiation in the ultraviolet range of the electromagnetic spectrum, adhesive performance was demonstrated, observed results of which are recorded below in Table 3D.

TABLE 3D

Sample Nos.//Lap shear
strength (MPa)

| | | LOCTITE |
|---|---|---|
| | | ECCOBOND |
| Substrates and Exposure | CE 1 | 9060F |
| PC-PC (UV 60 s + RT 5 min) | 1.22 | 1.29 |
| PC-PC (UV 60 s + RT 1 h) | 1.18 | 1.77 |
| PC-PC (UV 60 s + RT 24 h) | 2.1 | 2.04 |
| PC-PC (UV 60 s + RT 72 h) | 4.02 | 3.26 |
| PC-FR4 (UV 60 s + RT 5 min) | 2.05 | 1.73 |
| PC-FR4 (UV 60 s + RT 1 h) | 1.71 | 1.99 |
| PC-FR4 (UV 60 s + RT 24 h) | 4.06 | 2.06 |
| PC-FR4 (UV 60 s + RT 72 h) | 8.79 | 5.17 |

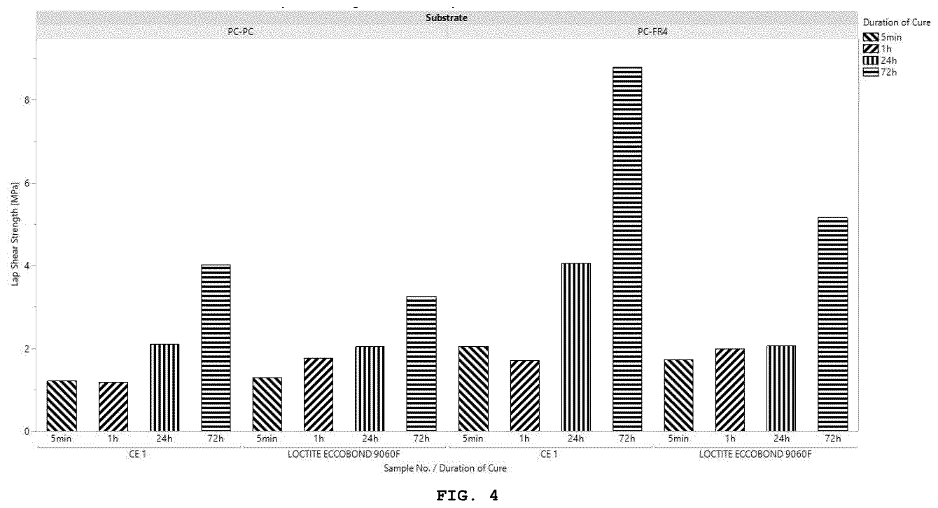

The performance in terms of force required to pull apart the bonded lap shear substrates was observed and recorded in Table 3D above and shown in the accompanying FIG. 4.

As noted above, each of Sample Nos. 3-6 demonstrated the benefit of achieving a level of adhesion when two substrates are mated, whether or not exposed to ultraviolet light. When exposed to ultraviolet light however it is seen that the level of adhesion improves by a factor of at least about 4 times, such as on polycarbonate substrates, when compared to CE 1 or LOCTITE ECCOBOND 9060F.

What is claimed is:

1. A two part adhesive composition comprising:
(a) a Part A composition comprising:
(i) a hydroxyl component comprising
a. at least two polyols, one of which includes a polyalkylene backbone and the other of which includes a polyester backbone, and each of which having a hydroxyl functionality of at least about 2, or
b. at least one hydroxyl group and at least one (meth)acrylate group; and
(ii) a catalyst; and
(b) a Part B composition comprising:
(i) an isocyanato-functionalized component; and
(ii) a compound having at least one isocyanato group and at least one (meth)acrylate group,
wherein at least one of the Part A composition or the Part B composition comprises a photoinitiator and a filler.

2. The composition of claim 1, wherein when the Part A composition and the Part B composition are mixed together, exposed to ultraviolet radiation at a wavelength of 365 nm for a period of time of about 60 seconds and permitted to cure at room temperature for a period of time of about 1 hour, the composition exhibits:
An adhesive strength of about 2 MPa or greater when disposed between two polycarbonate substrates.

3. The composition of claim 1, wherein when the Part A composition and the Part B composition are mixed together and permitted to cure at room temperature for a period of time of about 24 hours, the composition exhibits:
An adhesive strength of about 2 MPa or greater when disposed between two polycarbonate substrates.

4. The composition of claim 1, wherein when the Part A composition and the Part B composition are mixed together, exposed to ultraviolet radiation at a wavelength of 365 nm for a period of time of about 60 seconds and permitted to cure at room temperature for a period of time of about 24 hours, the composition exhibits:
An adhesive strength of about 6 MPa or greater when disposed between two polycarbonate substrates.

5. The composition of claim 1, wherein when the Part A composition and the Part B composition are mixed together, exposed to ultraviolet radiation at a wavelength of 365 nm for a period of time of about 60 seconds and permitted to cure at room temperature for a period of time of about 72 hours, the composition exhibits:
An adhesive strength of about 8 MPa or greater when disposed between two polycarbonate substrates.

6. The composition of claim 1, wherein when the Part A composition and the Part B composition are mixed together, exposed to ultraviolet radiation at a wavelength of 365 nm for a period of time of about 60 seconds and permitted to cure at room temperature for a period of time of about 1 hour, the composition exhibits:
An adhesive strength of about 3.5 MPa or greater when disposed a polycarbonate substrate and a FR-4 substrate.

7. The composition of claim 1, wherein when the Part A composition and the Part B composition are mixed together, exposed to ultraviolet radiation at a wavelength of 365 nm for a period of time of about 60 seconds and permitted to cure at room temperature for a period of time of about 24 hours, the composition exhibits:
An adhesive strength of about 10 MPa or greater when disposed a polycarbonate substrate and a FR-4 substrate.

8. The composition of claim 1, wherein each of the substrates is substantially transmissive to radiation in the ultraviolet range of the electromagnetic spectrum.

9. The composition of claim 1, wherein the hydroxyl component comprises poly(butadiene) and poly(carbonate).

10. The composition of claim 9, wherein the hydroxyl component further comprises poly(caprolactone).

11. The composition of claim 9, wherein the at least two polyols each have a Mw molecular weight in the range of about 500 g/mol to about 2,900 g/mol.

12. The composition of claim 9, wherein one of the at least two polyols has a Mw molecular weight in the range of about 500 g/mol to about 900 g/mol.

13. The composition of claim 9, wherein the other of the at least two polyols has a Mw molecular weight in the range of about 1,300 g/mol to about 2,900 g/mol

14. The composition of claim 9, wherein the at least two polyols are present in an amount within the range of about 25 to about 75 percent by weight, based on the total amount of the Part A composition.

15. The composition of claim 1, wherein the hydroxyl component further comprises a polyol having a polyamine backbone, with a hydroxyl functionality of at least about 2.

16. The composition of claim 1, wherein the hydroxyl component comprises poly(butadiene) having a hydroxyl functionality of about 2 to about 2.4 and poly(carbonate) having a hydroxyl functionality of about 2.

17. The composition of claim 1, wherein the hydroxyl component comprises a copolymer having butadiene residues and carbonate residues.

18. The composition of claim 1, wherein the hydroxyl component comprises a terpolymer having butadiene residues, carbonate residues and caprolactone residues.

19. The composition of claim 1, wherein the catalyst is a member selected from the group consisting of zinc-containing catalysts, tin-containing catalysts, bismuth-containing catalysts, and combinations thereof.

20. The composition of claim 1, wherein the catalyst is present in an amount in the range of about 0.1 percent by weight to about 1 percent by weight, based on the total weight of the composition.

21. The composition of claim 1, wherein the isocyanato-functionalized component is embraced by the following structure: 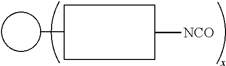
wherein:
x is an integer from about 1 to about 10;

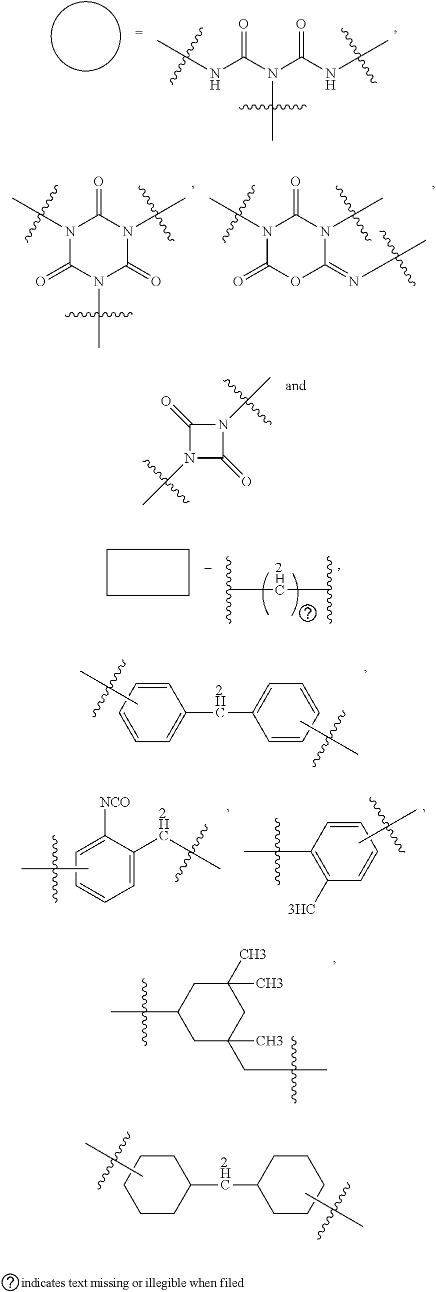

22. The composition of claim 1, wherein the isocyanato-functionalized component is present in an amount in the range of up to about 70 percent by weight, based on the total weight of the Part B composition.

23. The composition of claim 1, wherein the compound having at least one isocyanato group and at least one (meth)acrylate group is embraced by the following structure: 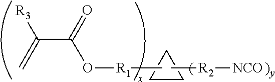
wherein:
x is from 1 to about 5;
y is from 1 to about 4;
R₁ and R₂ may or may not be present, but when present represent alkylene linkages of from one to about 10 carbon atoms, alkenylene linkages of from 2 to about 10 carbon atoms, alkynylene linkages of from 2 to about 10 carbon atoms, or arylene linkages of from 5 to about 12 carbon atoms; R₃ is hydrogen or an alkyl group of from one to about 10 carbon atoms; and

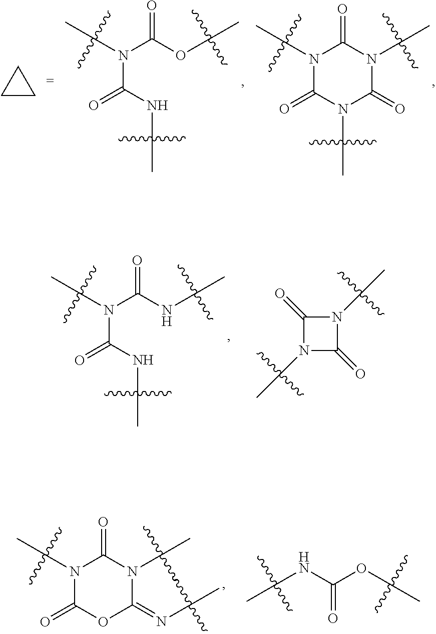

24. The composition of claim 1, wherein the compound having at least one isocyanato group and at least one (meth)acrylate group is present in an amount in the range of about 15 percent by weight up to below about 100 percent by weight.

25. The composition of claim 1, wherein the photoinitiator is a member selected from the group consisting of acylphosphine oxides, phenyl ketones, phenyl aceto ketones, alpha hydroxy ketones, diaryl ketones, Micheler's ketones, thioxanthones, quinones and 3-keto coumarins.

26. The composition of claim 1, wherein the photoinitiator is present in an amount in the range of about 0.5 percent by weight to about 2 percent by weight.

27. The composition of claim 1, wherein the filler is a silica.

28. The composition of claim 1, wherein the filler is present in an amount in the range of up to about 5 percent by weight.
